(19) United States
(12) Patent Application Publication
(10) Pub. No.: US 2009/0310362 A1
(43) Pub. Date: Dec. 17, 2009

(54) LIGHTING SYSTEM FOR A DISPLAY APPARATUS

(75) Inventor: Cornelis Jan Weij, Hendrik Ido Ambacht (NL)

Correspondence Address: MILLER, MATTHIAS & HULL, ONE NORTH FRANKLIN STREET, SUITE 2350, CHICAGO, IL, 60606, US

(73) Assignee: LiteCorp Europe B.V., Woerden (NL)

(21) Appl. No.: 12/307,216

(22) PCT Filed: Jul. 4, 2007
(86) PCT No.: PCT/EP2007/056774

§ 371 Date: Aug. 27, 2009

(30) Foreign Application Priority Data
Jul. 5, 2006 (EP) 06116675.7

(51) Int. Cl. F21S 4/00; F21S 8/00

(52) U.S. Cl. 362/249.02; 362/430

(57) ABSTRACT

A lighting system for a display assembly, in particular for a dispensing apparatus such as a chilled vending machine, including a track assembly and one or more LED lighting units releasably attachable to the track assembly and means for supplying DC electrical power to the lighting units attached to the track assembly is disclosed. A dispensing apparatus, in particular a low temperature dispensing apparatus such as a chilled vending machine is also disclosed. The track assembly is modular, including releasably interconnectable tracks, preferably having a continuous profile with electrodes

The present invention relates to a lighting system for a display assembly, in particular for a dispensing apparatus such as a chilled vending machine, comprising a track assembly and one or more LED lighting units releasably attached or attachable to the track assembly and means for supplying electrical power to the lighting units attached to the track assembly, and to a dispensing apparatus, in particular a low temperature dispensing apparatus such as a chilled vending machine.

In grocery stores, the products are usually stored on shelves and are illuminated to achieve a clear and attractive display of the goods Particular products may be highlighted with directional light beams or dynamic lighting effects. However, shelves and products stored thereon can cast shadows on their neighbouring shelves and products, so that staggered shelves or multiple light sources are generally required. In the case of frozen or chilled products, the goods are generally stored in dispensing apparatuses such as vending machines, glass front merchandisers etc. which are refrigeration or cooling units. In this case, as with all closed cabinet dispensing apparatuses, side walls and doors worsen the occurrence of shadows when lighting displayed products. It is therefore required to provide lighting elements inside the apparatus.

However, especially in cooling units, it is usually a problem that lamps generate heat. For this application incandescent lamps have been replaced by fluorescent lights which are generally brighter and generate less heat. A recent improvement is the use of light emitting diodes (LEDs), which generate even less heat and use less current. LEDs also usually allow a smaller fixture than a lamp or fluorescent tube.

For instance, US 2003/0137828 discloses a lighting system for low temperature environments including a plurality of light emitting diodes attached to a support member mounted within a refrigeration unit or the like for illuminating contents thereof. A reflector is disclosed adjacent to the light emitting diodes for dispersing the light therefrom. A light transmitting cover overlies the light emitting diodes, and preferably includes non-planar surfaces for dispersing light onto objects within the refrigeration unit.

U.S. Pat. No. 6,550,269 discloses a device for providing a number of products. The device may include an enclosure and a number of directional light emitting diodes positioned within the enclosure for illuminating the products.

Further, EP 1 627 583 discloses a chill cabinet which is lit by an LED lamp mounted at the top, above the side from which food is withdrawn. Each lamp has a housing with inlets for cool air from the cabinet.

However, LED lighting according to the prior art suffers from drawbacks similar to other light assemblies, i.e that LEDs, too, need cooling arrangements and in particular that when products and/or shelves of the display are rearranged differently, the lighting arrangement may not be optimal for the new situation and generally lacks flexibility in highlighting particular products.

It is therefore desired to provide an improved lighting system which substantially alleviates these problems and provides a lighting system which may more easily be adapted and allows flexibility in designing and constructing a display lighting arrangement.

To that end, in the lighting system according to the present invention the track assembly is modular, comprising releasably interconnected or interconnectable tracks, preferably having a continuous profile with electrodes.

Thus, the track assembly may be constructed into a spatial structure of tracks, e.g. containing a vertical stem and a number of branches, to any of which one or more lighting units may be attached. Tracks having a continuous profile, i.e. uninterrupted tracks or tracks having substantially the same cross section along their length, provide improved flexibility in attaching the lighting units thereto. Therefore, the lighting system allows to more easily construct and adapt any desired lighting arrangement for a particular display arrangement.

A DC power supply may provide power to the tracks which can be supplied directly to the LEDs. In that case, lighting modules may be provided with a DC-DC rectifier, such that the lighting module may be mounted to the track without having to consider or ensure correct polarity for the LED and/or other electronics of the lighting unit, e.g. by providing mechanical keying means.

For achieving an even greater flexibility, it is preferred that at least one, preferably each, of the lighting units comprises a connector for mechanically attaching and electrically connecting the lighting unit to a track, and, preferably arranged alongside the connector, a positioning part for orienting, such as rotating or pivoting, the light with respect to the connector. E.g., the positioning part may be rotatable about the connector and pivotable about another, e.g. independent, axis. In this way the lighting system can be adjusted to illuminate substantially each desired location.

Arranging the positioning part alongside the connector allows a relatively flat lighting unit, which protrudes little from the track. Thus, the distance between the light and illuminated objects can be kept relatively large, or conversely, objects can be placed closer to the track assembly and/or walls or shelves to which the track assembly is fastened.

In an embodiment, at least one, preferably each, lighting unit comprises at least one LED, which is, preferably releasably, mounted to a mounting comprising a heat sink. The mounting may comprise an electronic circuit board and the LED or LEDs may be thermally coupled to the heat sink by means of vias with a high heat conductivity, e.g. made of metal, through the circuit board.

In this way, the heat generated by the LED or LEDs can be led away and absorbed by and radiated from the heat sink, extending its reliability and durability. The electronic circuit board may carry electronics, e.g. for controlling properties of the LED or LEDs, such as current, power and the resultant light colour of the lighting unit, or filters to prevent voltage spikes from harming a LED. As circuit boards are generally insulating and poorly conduct heat, vias are provided to ensure an optimum thermal contact between the LED or LEDs and the heat sink, so that the heat sink may be mounted on the reverse side of a circuit board and cause heat to be radiated away from the heat sink in opposite direction to the emitted light, sparing nearby objects from direct heat. By this feature the exposed cooling and radiating surface area of the heat sink may be increased, without significantly increasing the thermal load on illuminated objects close to the lighting unit.

At least one, preferably each, lighting unit may be provided with a lens for achieving directional lighting, preferably spot-lighting, and/or a filter such as a colour filter, enabling highlighting effects to particular locations or objects for additional effect. Different lens-types, such as spherical, cylindrical or otherwise aspherically shaped lenses and/or masks may be used to achieve desired lighting patterns, which may not, or less effectively, be realised with regular light fixtures comprising no additional elements or just reflectors.

It is further possible that the lighting system comprises a control unit for generating a signal for controlling at least one lighting unit connected to the track assembly and wherein at least one, preferably each, lighting unit is provided with a receiver for detecting and processing the signal and means for adjusting parameters of the lighting unit such as the light power, colour temperature and/or orientation of the light.

In this manner, lighting units can be controlled to generate dynamic effects to the lighting arrangement, for instance to attract attention of potential customers, or to highlight one or more particular objects.

It is especially conceivable that at least one, preferably each, lighting unit is assigned an address which is unique within the lighting system, the address preferably being changeable by means of hardware and/or software settings, and that the control unit is adapted to generate control signals containing address information for individually controlling the corresponding lighting unit.

This allows to generate especially dynamic and attractive displays wherein individual parts of the display are controllably illuminated, as well as allowing additional effects such as using highlighting effects to indicate a product that a customer has selected in a chilled vending machine. Here, highlighting means that the illumination effect of a particular object or location differs from that of its, at least immediate, surroundings. Examples are a brighter, dimmer or differently coloured illumination or other light effects such as blinking.

Having a changeable address allows for using short addresses, e.g. only four or five bits (16 or 32 individual addresses, respectively) which may easily be set by hardware dipswitches on the lighting unit. It also facilitates the exchange of lighting units between different lighting systems wherein the particular address was already used, or it allows to assign the same address to several lighting units for achieving synchronous effects from the group of lighting units. Assigning addresses by means of software settings allows other known addressing techniques such as the use of virtual IP addresses. Of course, different or combined address assigning techniques are also possible. A software address may also efficiently be assigned automatically by the control unit during booting or re-booting of the control unit.

It is advantageous that in the lighting system according to the present invention at least one, preferably each, lighting unit further comprises a transmitter for transmitting signals, such as status information and preferably comprising address information of the lighting unit, to the control unit and the control unit further comprises a receiver for detecting and processing the signals from the lighting unit.

The status information may comprise operation information such as emitted power, light colour and LED temperature or other desired signals so that e.g. failures may be detected. Similarly, the data may be recorded by the control unit and stored e.g. for maintenance purposes such as timely detecting ageing of the LED or LEDs.

A very efficient lighting system is provided when the control signals are transmitted along at least one of the power supply lines as a modulated HF-broadband carrier signal or as short power dips or interruptions, e.g. representing a digital information signal and/or a clock pulse, which techniques enable a fast and large dataflow resulting in rapidly responding lighting units and smooth or abrupt lighting effects depending on the desired lighting effect. Transmitting the signals along at least one of the power supply lines removes the need for additional signal lines to lighting units, or for having to revert to wireless transmission techniques with associated noise problems. Thus, both the construction and maintenance of the lighting system are greatly simplified, further increasing the flexibility of the system.

For increased flexibility, the control unit is programmable for achieving a particular lighting arrangement and/or lighting effect, preferably using regular programming means with a user-friendly interface, such as a (portable) computer or a dedicated handheld device. The communication with the control unit may be in any known way such as via a data cable, a wireless technique such as radio, infrared or bluetooth links or via the internet. The program may, of course, also communicate with, or be part of, a general control program of a display device, e.g. a computer controlled vending machine with rotating coils.

A dispensing apparatus according to the invention, in particular a low temperature dispensing apparatus such as a chilled vending machine, comprises a lighting system or a lighting unit as discussed above. Thus, a dispensing apparatus is realised which enables maximum flexibility in designing and constructing as well as redesigning and changing the displaying of the goods, allowing to achieve an optimised and pleasing lighting arrangement every time, including highlighting and dynamic lighting effects.

It is advantageous to protect or shield parts of the lighting system from moisture due to condensation when it is used in a cold environment. E.g., electrodes and contacts may be manufactured from or coated with a corrosion-resistant material, such as being nickel-plated.

The invention will hereafter be explained in more detail by means of the figures showing embodiments of the present invention. The figures and the accompanying description are for exemplary purposes only and are not intended to limit the scope of the invention, which is defined by the attached claims.

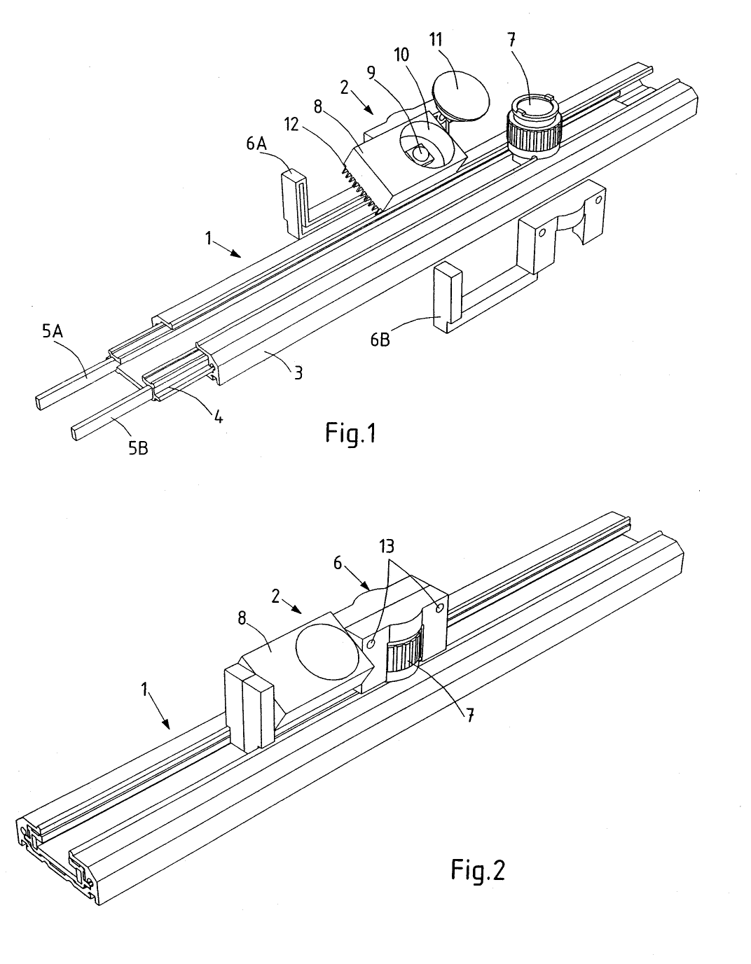

FIG. 1 shows a partially exploded view in perspective of a track and a lighting unit of a lighting system according to the present invention.

FIG. 2 shows a track and lighting unit of a lighting system according to the present invention in perspective.

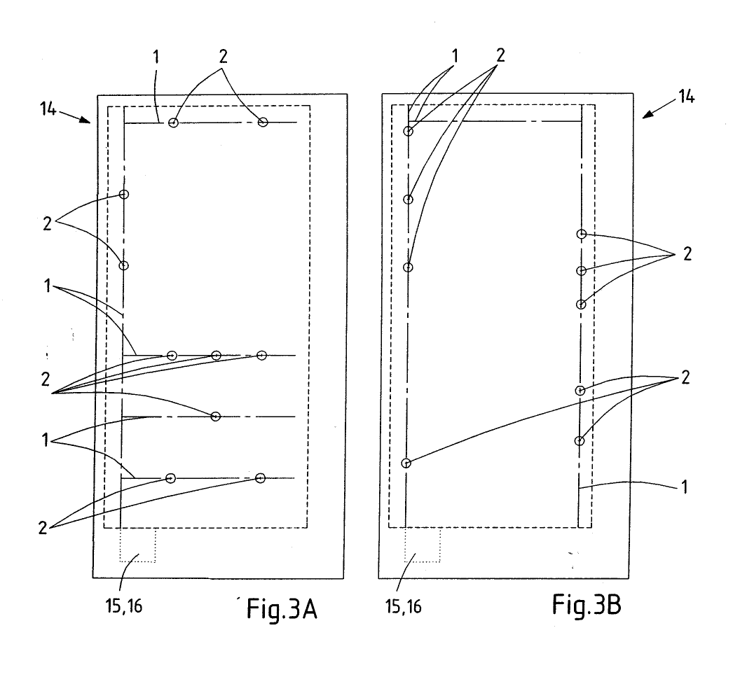

FIGS. 3A and 3B show two possible arrangements of a lighting system in a dispensing apparatus according to the present invention.

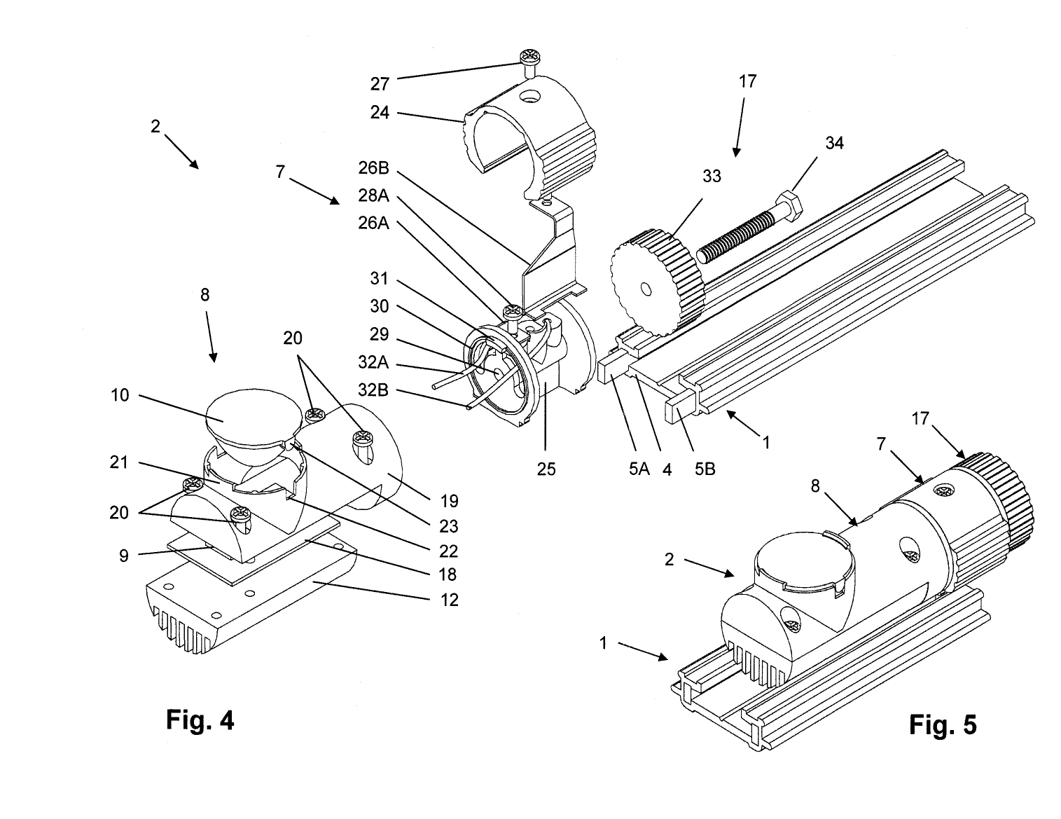

FIG. 4 shows a partially exploded view in perspective of a second embodiment of a track and a lighting unit of a lighting system according to the present invention.

FIG. 5 shows the track and lighting unit according to FIG. 4 in perspective and in mounted condition.

As may be seen in FIGS. 1 and 2, a lighting system according to the present invention comprises a track 1 and a lighting unit 2.

The illustrated track 1 comprises an extruded aluminium profile 3, a plastic profile 4 inserted therein, carrying two embedded electrodes 5A,5B, here in the form of copper conductors The cross section of the assembled track 1 is constant throughout its length.

The lighting unit 2 comprises a housing 6, here made with half-shells 6A,6B, a connector 7 and, arranged alongside the connector 7, a mounting 8 to which a LED 9, a reflector 10 and a cover or lens 11 are mounted.

As shown in FIGS. 3A and 3B, one or more tracks 1 can be releasably interconnected to a track assembly, e.g. by providing the tracks 1 with mating connectors or using additional coupling blocks (not shown) for coupling at straight or variable angles. Several tracks 1 may be joined to form one branching juncture.

Tracks, track adaptors, couplers and power supplies which have proven to be very well suited for use in a track assembly of a lighting system according to the invention are EUTRAC® 12V Low Voltage Low Profile Track system components, fabricated by EUTRAC, Germany. Other types of track are equally conceivable.

The mounting 8 of the lighting unit 2 further comprises a heat sink with cooling ribs 12 and a printed circuit board carrying electronics and a fixture for releasably mounting the LED 9 thereto. The LED fixture is connected to the heat sink 12 with a number of metal vias through the circuit board. The cooling ribs or fins of the heat sink 12 form, or protrude from, the rear surface of the mounting 8, facing away from the LED, providing maximum and unobstructed cooling to the LED 9. Further, as the heat is radiated away from the back of the mounting 8 in opposite direction to the light emission direction, direct heating of nearby illuminated objects is minimized.

In the example, the mounting 8 is pivotably mounted to the housing 6, so that the lighting direction of the LED 9 may be adjusted relative thereto. The connector 7 is a rotating clamping connector, provided with a T-shaped coupling head with electrical contacts at its tips. For coupling, the T-head is inserted into the track 1 in parallel thereto. At a desired position, the connector 7 is rotated by a quarter turn to provide a mechanical clamping connection to the track 1 and to bring the tips of the T-head into electrical contact with the electrodes 5A,5B. In reverse manner the connector 7 may be removed from the track 1.

In the shown embodiment, the housing 6 is rotatable about the connector 7, so that the orientation of the lighting unit 2, in particular that of the mounting 8, with respect to the track 1 can be adjusted. Upon clamping the connector 7 to the track 1, the housing 6 is also clamped down to the track 1 so that the position and orientation of the lighting unit 2 are fixed. Alternatively, the housing is attached to the connector by means of clamping screws 13 (FIG. 2), or any other fixing technique.

Thus, since the mounting 8 is pivotable about one axis, and rotatable about an axis perpendicular thereto, illumination is possible in substantially all angles relative to the track. As the units 2 are freely placeable along a track 1, being part of a modular track assembly, the lighting system provides substantially complete freedom to design and realise a desired lighting arrangement.

A suitable LED 9 for use in the lighting system according to the present invention is a warm white light LED with a colour temperature of 4500 K or a bright white LED with a colour temperature of 6500 K, e.g. of the Philips® Luxeon® K2 or Rebel series, which, especially in combination with a matching lens or reflector, provide an intense spot-light illumination pattern from the lighting unit.

The LED 9 may also be a coloured LED or, e.g., a trio of red, green and blue single colour LEDs in combination yielding white light, the colour temperature of which may be varied by adjusting the relative light intensities of the individual LEDs.

The reflector 10 may be highly reflective or diffusive such as, e.g., having a textured reflecting surface, a matte finish or being painted white, and may have any desired shape such as, e.g., conical, spherical or parabolic.

FIGS. 3A and 3B show a dispensing apparatus with a closed cabinet 14, provided with a lighting system according to the present invention. Several tracks 1 are constructed to a track assembly with a vertical stem and a number of branches, to which tracks a plurality of lighting units 2 is mounted. Thus two different lighting arrangements, each optimised for a different display within the apparatus are realised.

The lighting system is provided with a DC power unit 15 and with a control unit 16 which transmits and receives signals as commands and digital information signals along one of the electrodes 5A,5B of the tracks 1. The signals comprise addressing information for selectively addressing and controlling individual lighting units 2. The electronics of the lighting units 2 are adapted to detect the signals superposed or modulated on the power line, and to recognise and process command signals marked with the appropriate address signal and to control the current through the LED or LEDs accordingly, e.g. for switching on/off or dimming the LED. In a similar fashion status information on the power emitted from the LED is sent back by the lighting unit 2 to the control unit 16 for feedback and maintenance purposes. A suitable value for transmitting power is 12 Volt DC. Signals may be transmitted by pulsed reduction of the voltage to approx. 8 Volt, or even 0 Volt. Individual pulses or pulse trains may last for a few microseconds or up to several milliseconds. A low pass filter or a buffer capacitor may mask the power reduction to the LED.

As the control signals are transmitted along the power lines, a lighting unit 2 may be replaced to any other position on the track assembly, or the track assembly may be reconfigured, without having to reprogram the dynamic lighting effect obtained from that lighting unit 2 if so desired.

On the other hand, the control unit is reprogrammable, so that one or several different lighting programs or dynamic lighting effects may be altered, stored and run, so that the same spatial arrangement of the display obtains a “fresh look”, again attracting the attention of consumers which have may grown accustomed to the previously shown display.

FIGS. 4 and 5 show a second embodiment of a track 1 and a lighting unit 2, which functions substantially similar to the embodiment shown in FIGS. 1 and 2. Parts that are the same or equivalent to those shown in FIGS. 1 and 2 are identified with the same reference numerals.

The illustrated track 1 comprises a plastic profile 4 carrying two electrodes 5A,5B. Here, the track 1 does not comprise a metal profile 3 around the plastic profile 4 as in the embodiment of FIGS. 1 and 2.

The lighting unit 2 comprises a connector 7 and, arranged alongside the connector 7, a mounting 8 and opposite the mounting 8 an adapter screw 17.

The mounting 8 of the lighting unit 2 comprises a LED 9, a reflector 10, a heat sink with cooling ribs 12 and, fixed to the heat sink 12, a printed circuit board 18 carrying electronics and a fixture for releasably mounting the LED 9 thereto. Here, the mounting 8 further comprises a cover 19, fixed with screws 20 to the heat sink 12. The reflector 10 and/or a lens (not shown) and/or a mask (not shown) is/are snap-fitted to the cover 19 with latches 21. Optional recesses 22 are provided in the cover 19 for receiving optional cams 23 which may be provided on the reflector 10 and/or lens for alignment purposes, e.g. when employing a non-circular symmetric reflector 10, lens or mask.

The connector 7 comprises a spring cap 24 having profiled legs, a spring adapter 25, and two essentially identical contact springs 26A,26B. The spring cap 24 and the contact springs 26A,26B are attached to the spring adapter 25, here with screws 27 and 28A,28B, respectively. The spring adapter is further provided with a through hole 29, and on its front face, a stepped ring 30 and a cam 31. Two wires 32A,32B electrically connect the contact springs 26A,26B to the printed circuit board 18.

The adapter screw 17 comprises a knob 33 and a bolt 34, which are fixed to each other and may be a unitary object. The threaded shaft of (the bolt 34 of) the adapter screw 17 runs through the hole 29 in the spring adapter 25 and fits in a threaded hole (not shown) in the rear face of (the cover of) the mounting 8, such that the mounting 8 may be fixed against the spring adapter 25. The stepped ring 30 may be received in a stepped inward edge or groove (not shown) in the rear face of the mounting 8 for defining a number of rotational positions of the mounting 8 with respect to (the spring adapter 25 of) the connector 7. By loosening the adapter screw 17 the position of the mounting 8 may be changed. The available angle of rotation may be limited, e.g. to prevent damaging of the wires 32A,32B, by the cam 31 engaging stops on or in the mounting 8 (not shown).

The function of the stepped ring and groove may also be fulfilled by any other pair of matching profiles. Non-profiled faces of the spring adapter 25 and the mounting 8 may also be used for greater rotational flexibility. However, a certain roughness or friction of the surfaces is preferred for securing the relative position, e.g. against sagging of the mounting due to gravity.

The lighting module 2 is clamped with the connector 7 on the track 1 by an outward spring action of the spring contacts 26A,26B against the electrodes 5A,5B. For coupling, the legs of the spring cap 24 are pressed inwards, thereby pressing the tips of the spring contacts 26A,26B inwards, then the lighting module 2 is placed on the track at a desired position and the spring cap 24 is released The spring contacts 26A,26B may also be provided with bevelled legs for simply snapping the lighting module 2 to the track 1. The connector 7 may be removed from the track 1 by pressing the spring cap 24.

The invention is not restricted to the above described embodiments which can be varied in a number of ways within the scope of the claims.

For instance, one or more lighting units 2 may be provided with a motor for pivoting the mounting 8 of the lighting unit 2 and control signals may be used for the operation of the motor, causing the according illuminated spot to move.

It should further be noted that elements and functions presented in conjunction with one embodiment may be combined with those of another embodiment.

1-13. (canceled)

14. A lighting system for a display assembly, comprising:
a track assembly and at least one LED lighting unit releasably attached to the track assembly, the track assembly being connected to and a power supply line for supplying electrical power to the at least one LED lighting unit,
wherein the track assembly is modular, the track assembly comprising a plurality of releasably interconnected tracks, each track comprising a continuous profile with an electrode

15. The lighting system according to claim 14, wherein each LED lighting unit comprises a connector for mechanically attaching and electrically connecting each LED lighting unit to one of the tracks

16. The lighting system according to claim 15, wherein each LED lighting unit further comprises a positioning part for orienting, rotating or pivoting LED lighting unit with respect to the connector.

17. The lighting system according to claim 14 wherein each LED lighting unit comprises at least one LED and a mounting for supporting the at least one LED, the mounting comprising a heat sink

18. The lighting system according to claim 15 wherein each LED lighting unit comprises at least one LED and a mounting for supporting the at least one LED, the mounting comprising a heat sink

19. The lighting system according to claim 17, wherein the mounting further comprises an electronic circuit board and wherein each LED is thermally coupled to the heat sink by means of heat conducting vias that pass through the circuit board.

20. The lighting system according to claim 18, wherein the mounting further comprises an electronic circuit board and wherein each LED is thermally coupled to the heat sink by means of heat conducting vias that pass through the circuit board.

21. The lighting system according to claim 14 further comprising a control unit for generating a signal for controlling each LED lighting unit connected to the track assembly.

22. The lighting system according to claim 21, wherein each LED lighting unit comprises a receiver for detecting and processing the signals, each LED lighting unit further comprises means for adjusting parameters of the LED lighting unit, the parameters being selected from the group consisting of light power, color temperature and orientation of the light.

23. The lighting system according to claim 22, wherein each LED lighting unit is assigned an address which is unique within the lighting system, the address preferably being changeable by means of hardware and/or software settings, and wherein the control unit is adapted to generate control signals containing address information for individually controlling the corresponding LED lighting unit.

24. The lighting system according to claim 23 wherein each LED lighting unit further comprises a transmitter for transmitting signals to the control unit and the control unit further comprises a receiver for detecting and processing the signals from each LED lighting unit.

25. The lighting system according to claim 24, wherein the signals are transmitted along the power supply line in a format selected from the group consisting of a modulated HF-broadband carrier signal, a digital information signal and a clock pulse

26. The lighting system according to claim 21, wherein the control unit is programmable for achieving at least one lighting effect.

27. The lighting system according to claim 14, wherein each track transmits DC power to each LED lighting unit, each LED lighting unit comprises a rectifier.

28. The lighting system according to claim 14, wherein the electrodes comprise a corrosion-resistant material

29. An LED lighting unit for a lighting system, comprising:
a connector for mechanically attaching and electrically connecting the LED lighting unit to a track;
a positioning part for orienting, rotating or pivoting, the LED lighting unit with respect to the connector;
a mounting for supporting at least one LED, the mounting comprising a heat sink, the mounting further comprises an electronic circuit board and wherein each LED is thermally coupled to the heat sink by means of heat conducting vias that pass through the circuit board; and
a transmitter

30. A dispensing apparatus comprising a lighting system of claim 1

31. A dispensing apparatus comprising an LED lighting unit of claim 29.
